(19) United States
(12) Patent Application Publication
(10) Pub. No.: US 2018/0089614 A1
(43) Pub. Date: Mar. 29, 2018

(54) AUTO REPLENISHMENT OF CONSUMABLES FOR SMART DEVICES

(71) Applicant: Target Brands, Inc., Minneapolis, MN (US)

(72) Inventors: Adam M. Laskowitz, San Francisco, CA (US); Aadil Rhazi, San Mateo, CA (US); Yeshwanth M. Gowda, Walnut Creek, CA (US); Christian P. Knuetter, San Francisco, CA (US); Faith J. Hutchinson, Berkeley, CA (US); Patricia S. Adler, Oakland, CA (US); Matthias C. Margush, San Francisco, CA (US)

(21) Appl. No.: 15/712,878

(22) Filed: Sep. 22, 2017

Related U.S. Application Data
(60) Provisional application No. 62/398,618, filed on Sep. 23, 2016.

(51) Int. Cl. G06Q 10/08; G06Q 10/04; G06Q 10/06; H04L 12/58

(52) U.S. Cl. CPC G06Q 10/087; G06Q 10/04; H04L 51/38; G06Q 10/06375; H04L 51/32; G06Q 10/06316

(57) ABSTRACT

An auto replenishment service is in Internet communication with a smart device registered with the auto replenishment service and monitors consumption of consumables by the smart device for an account holder. The auto replenishment service receives consumption events and processes the consumption events to automatically request orders for the consumable on behalf of the account holder from a retail fulfillment service over the Internet.

### CROSS-REFERENCE TO RELATED APPLICATION

The present application is based on and claims the benefit of U.S. provisional patent application Ser. No. 62/398,618, filed Sep. 23, 2016, the content of which is hereby incorporated by reference in its entirety.

### BACKGROUND

Smart devices are electronic devices embedded with electronics, software, sensors and network connectivity, which enables these devices to collect and exchange data. Smart devices can be sensed and controlled remotely across existing network infrastructure using an associated application (i.e., an app) downloaded on a mobile device and, thereby, creating opportunities for the integration of the physical world with computing systems and resulting in improved efficiency, accuracy and economic benefit. Oftentimes smart devices use consumables, which need to be replenished over time.

The discussion above is merely provided for general background information and is not intended to be used as an aid in determining the scope of the claimed subject matter.

### SUMMARY

An auto replenishment system includes an auto replenishment service in Internet communication with a third party that controls operation of a smart device registered with the auto replenishment service and monitors consumption of consumables by the smart device for an account holder. The auto replenishment service receives consumption events from the third party, processes the consumption events received from the third party to automatically request orders for the consumable on behalf of the account holder from a retail fulfillment service over the Internet. The auto replenishment service includes: an event processor that recalculates an amount of the consumable associated with the registered smart device based on the consumption events, a prediction engine that determines, based on historical use of the consumable by the registered smart device, whether the consumable needs to be restocked and an order management component that sends notification to the retail fulfillment service requesting a reorder of the consumable.

A method is provided for automatically reordering consumable for a smart device. A processor receives an event involving use of the consumable with a registered smart device. The processor calculates a remaining amount of the consumable associated with the registered smart device based on the received event. The processor determines, based on the remaining amount and historical use of the consumable by the registered smart device, whether the consumable needs to be restocked for the registered smart device and a request is sent to a retail fulfillment service to reorder the consumable.

An auto replenishment system includes a plurality of smart devices each configured to consume a consumable. The plurality of smart devices perform similar and different functionalities from each other and provide consumption events related to consumption of the consumable. The auto replenishment system also includes an auto replenishment service in communication with the plurality of smart devices and configured to receive the consumption events from each of the plurality of smart devices for processing. The auto replenishment service recalculates an amount of the consumable available to each smart device based on the consumptions events, determines, based at least on historical use of the consumable used by each smart device, whether the consumable needs to be reordered and reorders the consumable from a retail fulfillment service based on the determination.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic diagram illustrating an auto replenishment system according to one embodiment.

FIG. 2 is a more detailed diagram of an auto replenishment service of the auto replenishment system of FIG. 1.

FIG. 3 is a flowchart illustrating steps performed by the auto replenishment service in FIGS. 1 and 2 for registering a third party and their particular smart device model.

FIG. 4 is a flowchart illustrating steps performed by the auto replenishment service in FIGS. 1 and 2 for registering and activating an account holder and a specific smart device.

FIGS. 5-11 is a mobile device and associated screenshots illustrating the steps shown in FIG. 3.

FIGS. 12A-12C is a mobile device illustrating three screenshots providing the entirety of a main graphical interface accessible through a web container in a third party app for an account holder of the auto replenishment service.

FIG. 13 is a flowchart illustrating steps performed by the auto replenishment service in FIGS. 1 and 2 for automatically ordering consumable.

FIGS. 14-18 is a mobile device and associated screenshots illustrating an exemplary discovery feature of the auto replenishment service in FIGS. 1 and 2.

FIG. 19 provides a block diagram of a computing device that can be used in the various embodiments.

### DETAILED DESCRIPTION

Described below is an auto replenishment system for consumables of smart, connected devices that are based on use. The auto replenishment system includes an auto replenishment service that functions as an intermediary service between a retail back-end and third party or partner or other type of smart device makers. Fulfilled by existing channels in the back-end, the intermediary service enables the ability for smart device makers to automatically order and reorder consumables on behalf of a user.

One existing consumer goods Internet ordering service is a subscription service. In this type of service, a user chooses consumables for purchasing by selecting the number of items a user wants to receive, the frequency of delivery and a start date. While a feature of the service allows a user to skip deliveries, the user must remain engaged in keeping track of the amount of consumables consumed and the amount needing to be ordered.

Another existing consumer goods Internet ordering service uses a proprietary Wi-Fi-enabled connected device for ordering goods over the Internet. In one example, the proprietary device is a barcode scanner that allows users to build a shopping list by scanning bar codes on consumables and saying consumable product names out loud. In another example, the proprietary device contains an embedded button or switch emblazoned with the name of an often ordered consumable. Users can configure each device to order a specific product and quantity and mount those devices to a location where a user uses those products. Pressing the button or switch sends a Wi-Fi signal to an app, which orders new stock of the consumable that the button or switch is configured to order.

Yet another existing consumer goods ordering service uses a smart device that is set up to automatically order consumables over the Internet. This type of service is a “set it and forget it” type of service where smart device makers integrate service APIs into their smart devices and place orders on behalf of their customers. The third party smart device makers must keep track of consumables used and determine when consumables need to be ordered.

Contrary to the “set it and forget it” type of consumer goods ordering service described above, embodiments of the auto replenishment system described herein provide a tangible experience for the user without the user having to remain fully engaged in the amount of consumables consumed and the amount of consumables needed to be ordered. Such an auto replenishment system includes a user interface including information related to the user embedded into a smart device maker's app. For example, the user interface may be inside a web container of a smart device maker's app that helps users understand things like ship/order status, product pricing and product and service discovery. In addition, the auto replenishment system provides a prediction engine for predicting when consumables need to be ordered for a variety of different smart devices rather than merely a “place order” capability. This eliminates the need for smart device makers to make decisions regarding when consumables need to be ordered for each individual type of smart device. Rather, a single prediction engine is provided that can make these decisions no matter how many or what type of smart devices are using the service, thus making a much more efficient ordering system for all parties involved.

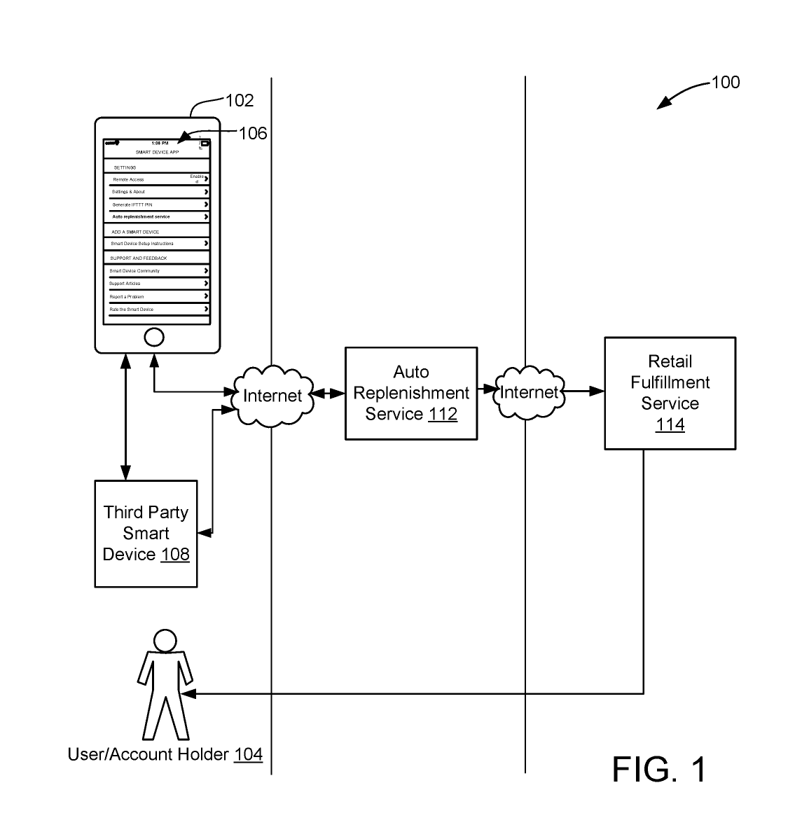

FIG. 1 is a schematic diagram illustrating an auto replenishment system 100 according to one embodiment. In one embodiment and as shown in FIG. 1, auto replenishment system 100 can be run on a plurality of one or more individual servers that communicate over the Internet. Auto replenishment system 100 includes a mobile device 102, a user/account holder 104 who operates mobile device 102, a smart device 108, a smart device maker app 106 downloaded onto mobile device 102 that allows user/account holder 104 to control smart device 108, an auto replenishment service 112 and a retail fulfillment services 114. It should be realized that while there is only one auto replenishment service 112 shown (which may or may not run on multiple computers or servers) in system 100, there will be many mobile devices 102, account holders 104 with smart devices 108, instances of smart device maker apps 106 downloaded onto the various mobile devices 102 and one or more retail fulfillment services 114. Providing one or more retail fulfillment services provide(s) account holders more flexibility in price of consumables and variety of type of consumables that may be purchased.

Auto replenishment service 112 intakes consumption events from smart device 108 or smart device maker app 106 over the Internet and processes this information to determine when user/account holder 104 needs more consumable for smart device 108. Upon a threshold being met, auto replenishment service 112 requests retail fulfillment service 114 to fulfill an order for a consumable.

As previously discussed, auto replenishment service 112, which is the intermediary service between third party service 110 and retail fulfillment service 114, includes a user interface software or plugin for integration into smart device maker app 106 by, for example, a web container, such as an HTML container. Mobile device 102 can communicate with auto replenishment service 112 through the user interface using a provisioned authentication token which maps a user or account holder 104 to customer data stored by retail fulfillment service 114. Auto replenishment service 112 handles requests to display content to the user/account holder 104 through the user interface in smart device maker app 106, may ping a smart device maker callback server when an automatic order is taking place and handles user actions to delay order placement.

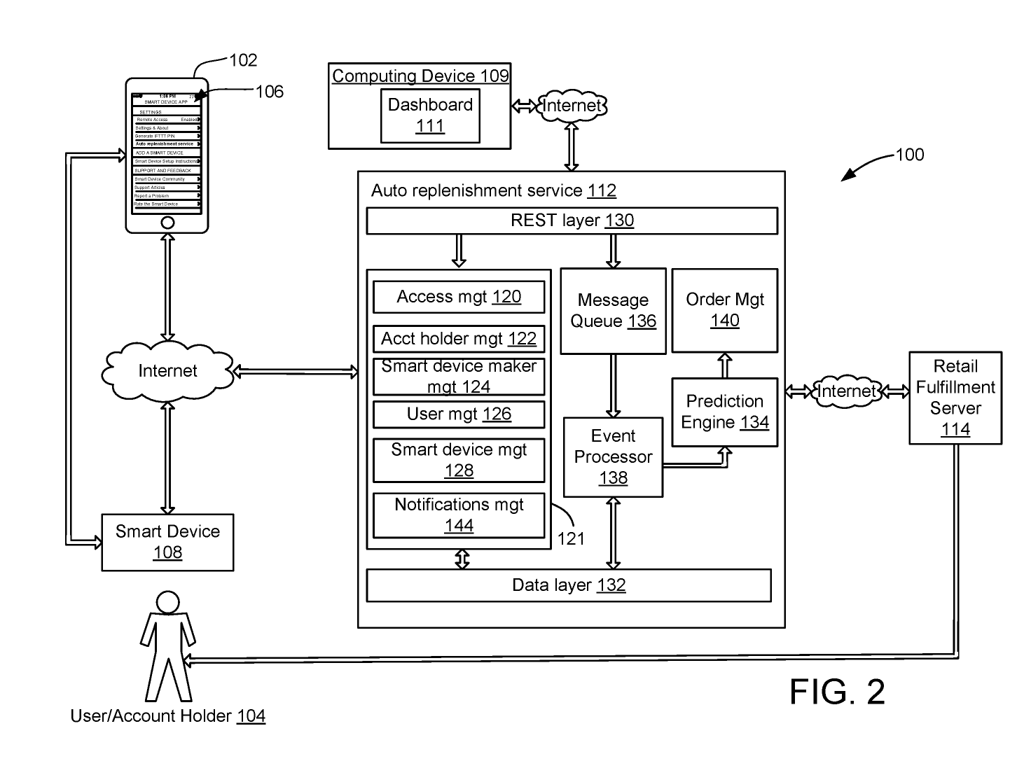

FIG. 2 is a more detailed diagram of one embodiment of the architecture of auto replenishment service 112. More specifically and in one embodiment, auto replenishment service 112 includes a REST layer 130, which is an API framework that helps create a comprehensive, customizable and secure REST API on top of a pluggable backend. It should be realized that other API frameworks may be used. Auto replenishment service 112 also includes management service APIs all contained within box 121 including, but not limited to, access management 120, account holder management 122, smart device maker management 124, user management 126, smart device management 128 and notifications management 144. Auto replenishment service 112 also has event processor APIs including, but not limited to, message queue 136, event processor 138, prediction engine 134 and order management 140.

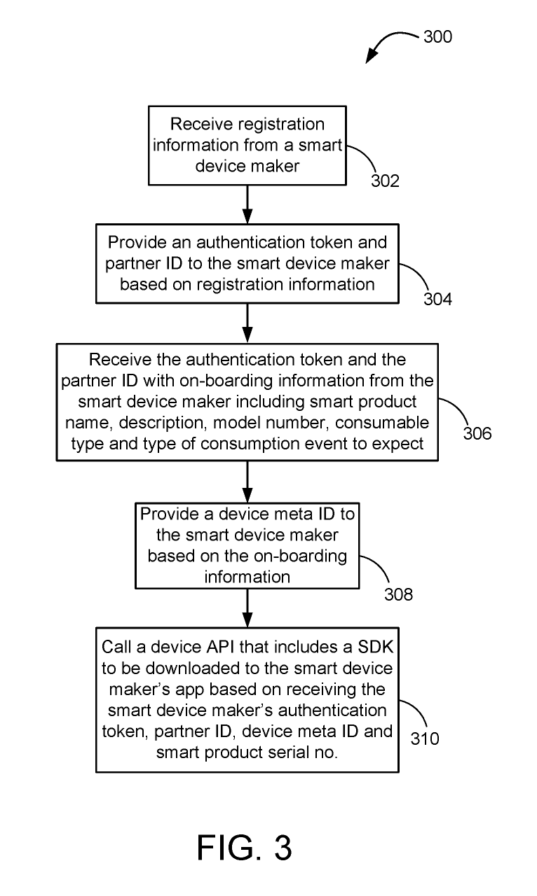

Before discussing the creation of an account for a user and registering a particular smart device 108 with auto replenishment service 112, FIG. 3 is a flowchart 300 illustrating steps performed by auto replenishment service 112 when a smart device maker makes a request to join auto replenishment service 112. To do so, the smart device maker (not specifically shown in FIG. 1 or 2) fills in a fillable form generated by auto replenishment service 112 that includes registration information. At block 302, the fillable form includes the name of the company, a pin number and contact information. Auto replenishment service 112 receives the form through a dashboard or user interface 111 on a computing device 109 and privileged access is granted. Access management 120, which is a processing element of auto replenishment service 112 that includes instructions for processing/transforming data, approves access by the smart device maker, provides an authentication token and a partner identification (ID) number at block 304 in flowchart 300. The authentication token and partner ID are sent to dashboard 111.

Upon receipt of the authentication token and partner ID, the smart device maker submits to and auto replenishment service 112 receives on-boarding information at block 306 of flowchart 300 using the authentication token and partner ID via smart device maker management 124. On-boarding information includes the smart device name being on-boarded, description, model number, and consumable type for that model number. For example, if the smart device being on-boarded is a smart coffee maker then the brand name of the maker, a description of the maker, a model number of the maker and the consumable to which the maker uses, such as coffee, is received by auto replenishment service 112. If the smart device being on-boarded is a smart toothbrush then the brand name of the maker, a description of the maker, a model number of the maker and the consumable to which the maker uses, such as toothpaste, is received by auto replenishment service 112. Also received from the smart device maker is a type consumption event auto replenishment service 112 should expect to receive from that particular smart device.

Because all smart devices are either functionally similar or functionally different and use similar or different types of consumables in similar or different ways and because new users will be constantly on-boarding with new smart device that have had no consumption events, one of the key features of the embodiment disclosed herein is an auto replenishment service 112 that can receive different types of consumption events from different smart devices and yet still be able to make accurate predictions of use and when consumables need to be reordered.

In one embodiment, auto-replenishment service 112 may categorize consumptions events into three types: a non-deterministic event, a semi-deterministic event and a deterministic event. These types of information are called device meta and auto replenishment service 112 receives from each third party which of these three types of consumption events they will be supplying to auto replenishment service 112.

An example of a non-deterministic consumption event includes the occurrence of a use of the smart device that includes a timestamp. An example of a semi-deterministic event includes the occurrence of a use of the smart device in the form of a duration of use and a timestamp. An example of a deterministic event includes the occurrence of a use of the smart device in the form of an exact quantity or amount of consumable used. This quantity will include a measure and a unit. Upon a smart device maker submitting the device meta during on-boarding for the particular model of smart device, auto replenishment service 112 sends a device meta ID to the smart device maker at block 308.

At block 310, auto replenishment service 112 receives from the smart device maker their authentication token, partner ID, device meta ID and smart device serial no. and calls a device API that includes the software development kit (SDK) to be downloaded by the smart device maker for embedding into the smart device maker's app 106. After the smart device maker inserts the SDK into their app 106, the maker's smart device is ready for user registration with auto replenishment service 112.

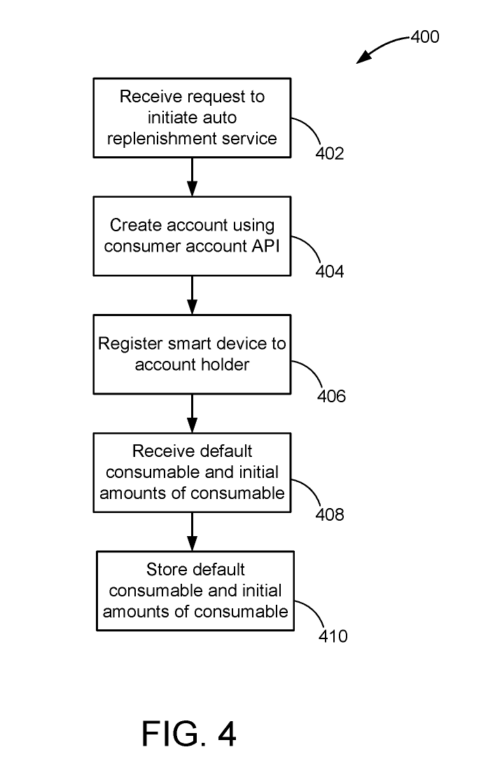

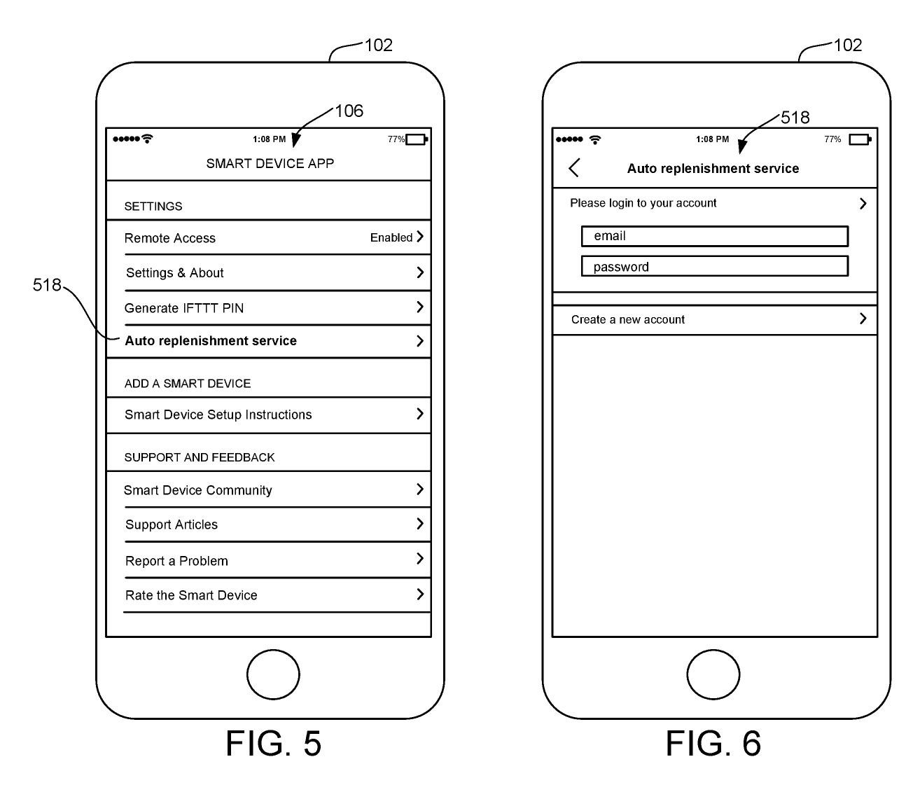

FIG. 4 is a flowchart illustrating steps performed by auto replenishment service 112 for registering and activating a user, such as account holder 104 and the account holder's smart device 108. At block 402, auto replenishment service 112 receives a request from smart device maker app 106 to initiate the ordering of consumables for smart device 108 owned and operated by a user 104. FIG. 5 illustrates an enlarged view of mobile device 102 and an associated screenshot of smart device maker app 106 illustrating a heading 518 through which a user interface of auto replenishment service 112 is accessed. After the user selects heading 518, FIG. 6 illustrates mobile device 102 and an associated screenshot provided to a user 104 from inside the user interface for either creating an account with auto replenishment service 112 or logging into auto replenishment service 112 if the user is already an account holder having a registered account.

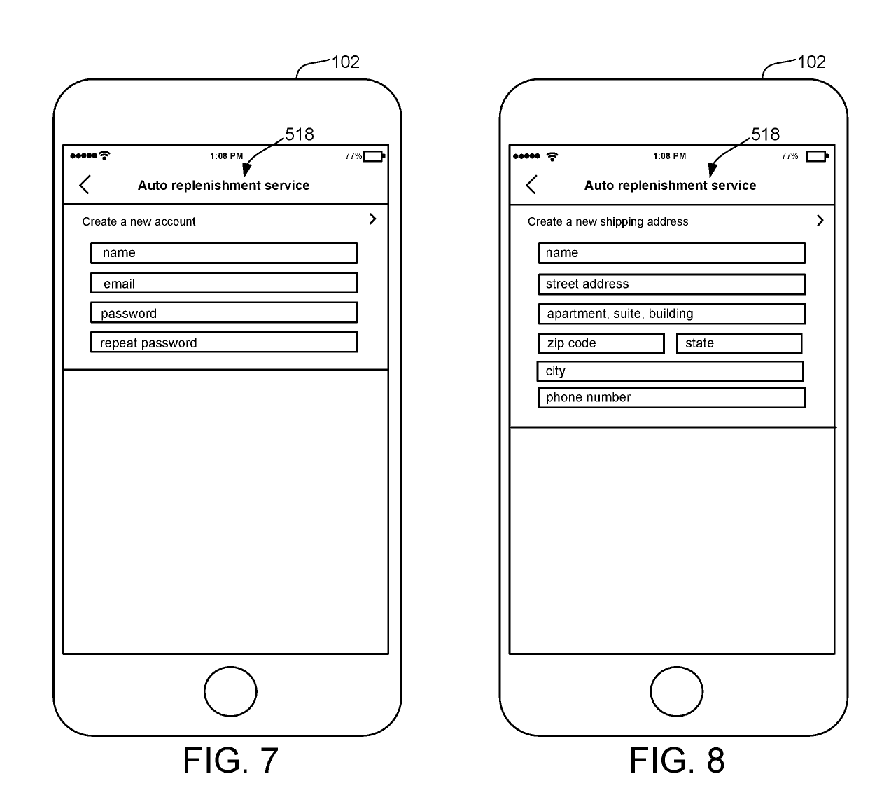

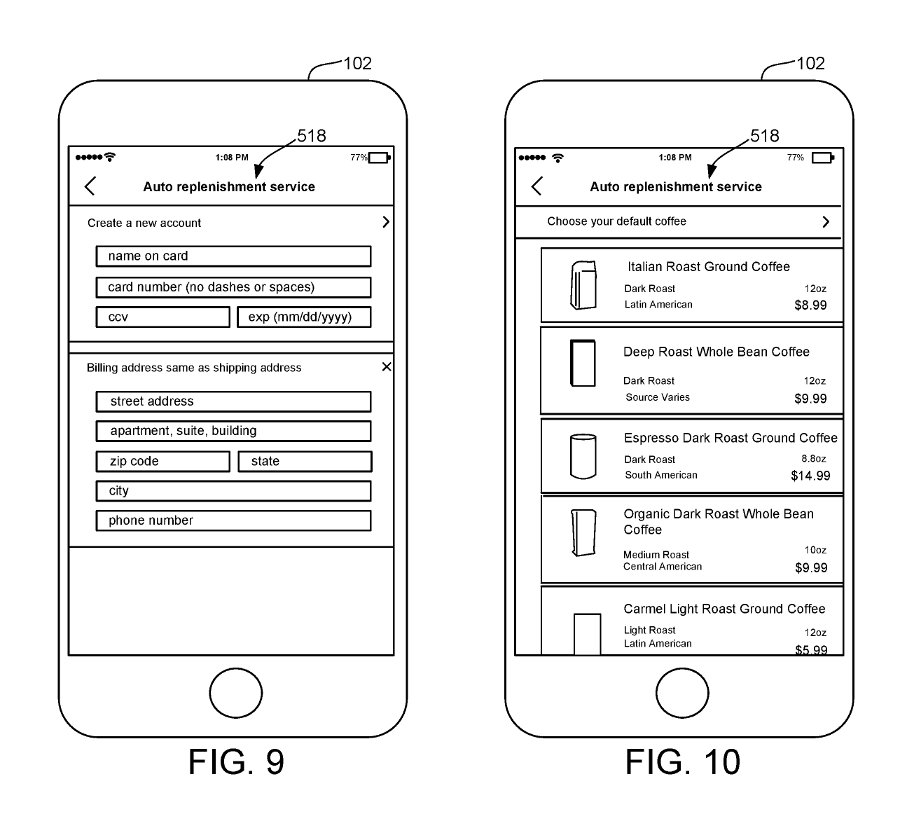

At block 404, account holder management 122 of auto replenishment service 112, which is a processing element that includes instructions for processing/transforming data, creates an account API. FIGS. 7 and 8 illustrate associated screenshots providing the user interface to the user 104 via mobile device 102 to create an account. In FIG. 7, name, email and password are filled in by user 104, and in FIG. 8, a shipping address is entered by user 104. FIG. 9 illustrates an additional screenshot of a user interface provided to user 104 via mobile device 102 during account creation. In FIG. 9, credit card information including a billing address is entered by user 104. If, on the other hand, an account has already been created for user 104, then auto replenishment service 112 merely logs in user or account holder 104. During this process, credentials are received and authentication is granted.

At block 406, auto replenishment service 112 registers smart device 108 to account holder 104. Information regarding account holder 104, the smart device maker, the user before they became an account holder 104 and the smart device 108 registered to the account holder 104 is managed in account holder management 122, smart device maker management 124, user management 126 and smart device management 128. Elements 122, 124, 124 and 128 are all processing elements that include instructions for processing/transforming data.

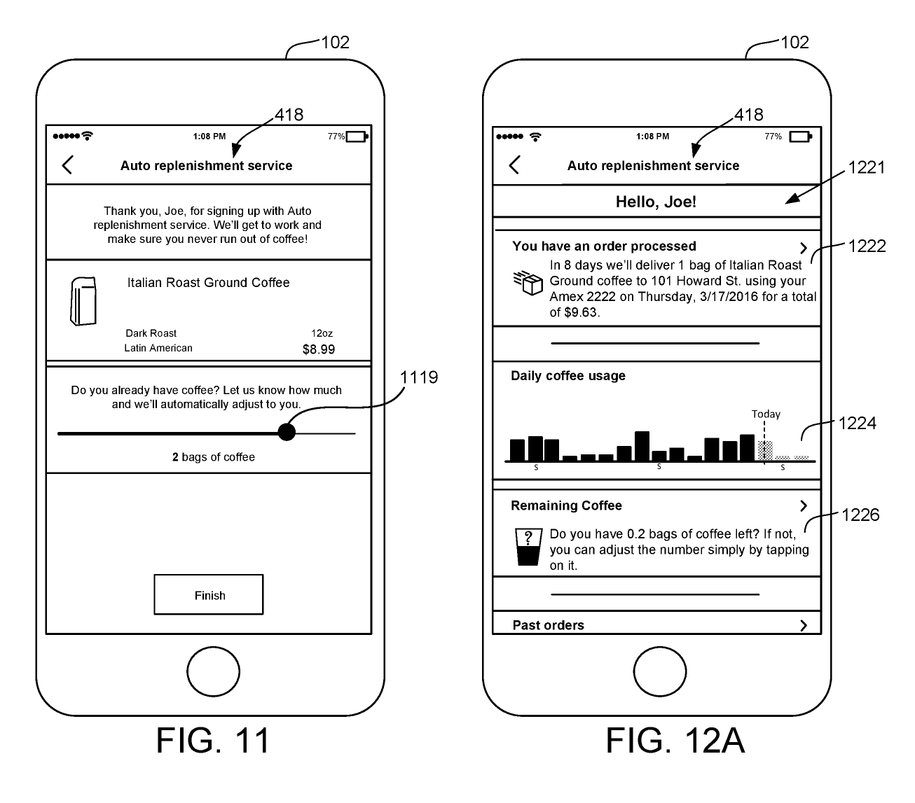

At block 408, auto replenishment service 112 receives a default consumable and initial amount of consumable that are both tied to smart device 108 and account holder 104. FIG. 10 illustrates an associated screenshot that provides a menu of selections for selecting the default consumable. In the FIG. 10 embodiment, the consumable being selected is coffee for a smart coffee maker. Each selection shows at least an image, a description, a quantity and price of the consumable. FIG. 11 illustrates an associated screenshot of a user interface providing a toggle button 1119 for setting the amount of the consumable that account holder 104 currently has. Toggle button 1119 is a sliding button with quantities being described and changed below depending on the location of button 1119 on a slide. It should be realized, however, that other types of user inputs to set the amount of consumable that account holder 104 has are possible. At block 410, the default consumable and initial amounts of consumables are stored in data layer 132 for later access by various processing components in auto replenishment service 112.

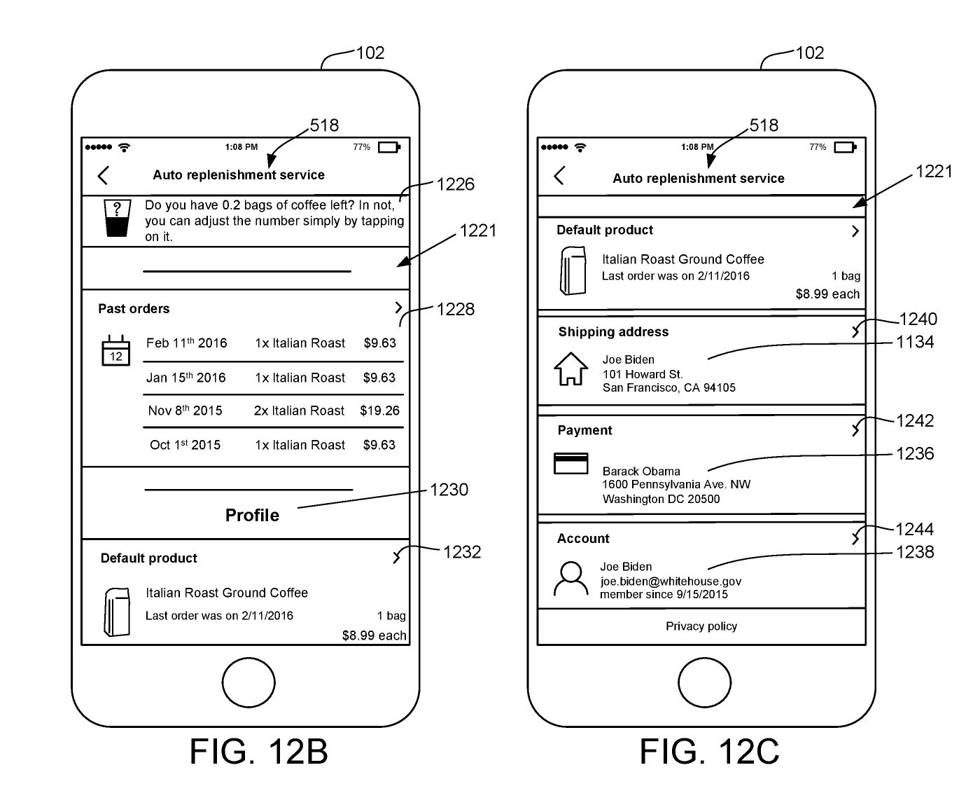

FIGS. 12A-12C illustrate three screenshots providing a main graphical interface 1221 to an account holder 104 under heading 518 on their mobile device 102 when account holder 104 is signed in and registered with auto replenishment service 112. Main graphical interface 1221 is larger than the display on mobile device 102 and account holder 104 must scroll down to view all of graphical interface 1221. FIG. 12A is the top portion of main graphical interface 1221, FIG. 12B is a middle portion of main graphical interface 1221 and FIG. 12C is a bottom portion of main graphical interface 1221.

As illustrated in FIGS. 12A-12C, main graphical interface 1221 first conveys whether an order 1222, if any, has been processed for account holder 104, the day and time of that order, the total cost and when the order will be delivered. The second item on main graphical interface 1221 conveys is a bar graph 1224 of daily consumable usage. As illustrate in FIG. 12A where the consumable is coffee and the smart device that is tied to the account holder 104 is a smart coffee maker, the weekends appear to account for a great deal of the consumable usage (i.e., coffee). This data is compiled from data logged by third party server 110 and is conveyed to auto replenishment service 112.

Next, main graphical interface 1221 conveys a prediction 1226 calculated by auto replenishment service 112 on how much coffee account holder 104 should have left based on usage. If the prediction is incorrect, main graphical interface 1221 allows account holder 104 to change this piece of predicted data. Predictions made by auto replenishment service 112 and its prediction engine 134 will be discussed in more detail below. FIG. 12B, which illustrates the middle portion of main graphical interface 1221, includes a summary 1228 of the most recent orders. Each recent order listed includes the order date, the type of consumable purchased and the total cost.

Under a profile section 1230 of main graphical interface 1221, account holder 104 can view the current default consumable and when the last order of that default consumable was made. By tapping on the arrow located on the right side of the interface or by using some other type of user input, account holder 104 can change the default consumable. FIG. 12C, which illustrates the bottom portion of main graphical interface 1221, shows the current shipping address 1234, the current method of payment 1236 and account holder details 1238 including contact information. Using arrows 1240, 1242 and 1244 located on the right side, any of these pieces of information can be changed or updated.

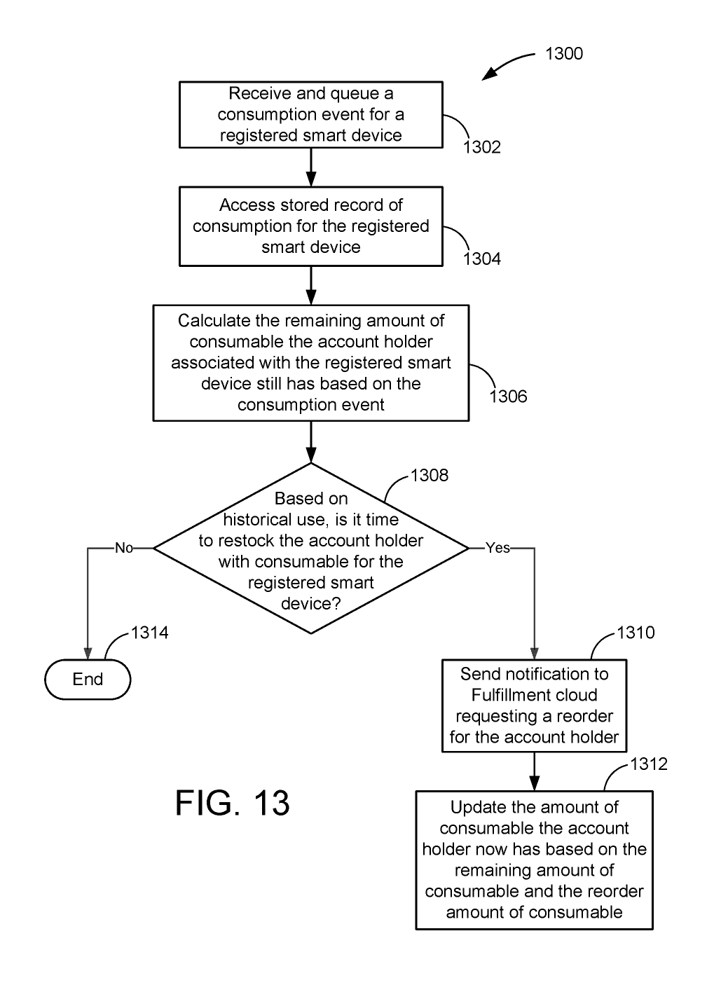

FIG. 13 is a flowchart 1300 illustrating steps performed by auto replenishment service 112 for automatically ordering a consumable. With reference back to FIG. 2, at block 1302, auto replenishment service 112 receives a consumption event from third party server 110 regarding registered smart device 108. The consumption event is queued in message queue 136. In one embodiment and as previously described, this consumption event may be one of a non-deterministic consumption event (i.e., only that a use occurred at a specific time), a semi-deterministic consumption event (i.e., a use occurred at a specific time for a specific duration) or a deterministic consumption event (i.e., a use occurred and a particular quantity including a measure and unit was consumed).

When the event is ready to be processed, at block 1304, event processor 138, which is a processing element that includes instructions for processing/transforming data, accesses a stored record of consumption from data layer 132 for registered smart device 108 based on the account holder and device ID information in the event. Given the accessed record, at block 1306, event processor 138 recalculates the amount of consumable that account holder 104 should have left based on the consumption event. Further, event processor 138 stores this new amount in data layer 132 and passes the new amount onto prediction engine 134, which is also a processing element that includes instructions for processing/transforming data.

At block 1308, prediction engine 134 determines, based on historical use of account holder 104, if it is time to restock account holder 104 with the consumable. More specifically, prediction engine 134 includes an algorithm for making predictions. While the algorithm remains the same across all types of smart devices, each type (i.e., smart device model) will need have a model developed over time based on the consumption event. For example based on the type of consumption event (i.e., non-deterministic, semi-deterministic and deterministic) the smart device includes in its device meta as under one embodiment. In the embodiment where a smart device informs auto replenishment service 112 of a deterministic consumption event, the model will be able to determine how much quantity of consumable is left quite easily. For a smart device that informs auto replenishment service 112 of a semi-deterministic consumption event or non-deterministic consumption event, the models will have to estimate quantities based on other external factors including the average use of consumable by the average person for that particular type of smart device model until a history of use of the account holder's use can be established. For example, in the case of the account holder from FIGS. 12A-12C, prediction engine 134 would predict a shorter time to restocking if the consumption event takes place right before the weekend, when use of the consumable is at its highest. Likewise, prediction engine 134 would predict a longer time to restock if the consumption event takes place right after a weekend, when use is at its lowest.

If prediction engine 134 decides account holder 104 needs to restock the consumable, then prediction engine 134 instructs order management 140 to place an order. At block 1310, order management 140, in turn, sends a notification to retail fulfillment service 114 (FIG. 1) over the Internet requesting a reorder for account holder 104. At block 1312, auto replenishment service 112 then updates the amount of consumable that account holder 104 will have on the date of delivery and when that date will occur. If prediction engine 134 determines that no new consumable needs to be order at step 1308, the method ends at block 1314.

By off-loading all of the consumption events, predictions and ordering of the consumable to auto replenishment service 112 onto a single event processor 138 and prediction engine 134 that can process all type of consumables of all different types of smart devices, smart device makers need not have to implement their own prediction engines, which is inefficient. In addition, a better determination of the amount of the consumable account holder 104 has, will have and needs is made. If the processes of predicting when consumable needs to be reordered was regulated to the smart device makers and smart device makers was merely sending orders to a fulfillment service, the smart device makers would not in turn be able to confirm receipt of delivered consumable unless the account holder 104 did so via app 106. Also, by offloading all of the consumption events, predictions and ordering of consumable to auto replenishment service 112, more retail “shopless” experiences can be offered to account holder 104 that a third party server does not have access to. A “shopless” experience means being made aware of products for purchase, but by not actually being in a brick and mortar store to be made of aware of those products. The following paragraphs will discuss this in more detail.

Auto replenishment service 112 is also capable of helping account holders find the best deals on consumables. Because of its connection to retail fulfillment service 114 and the fact that retail fulfillment service 114 can be multiple different retail fulfillment entities, auto replenishment service 112 has access to the best deals on a variety of consumables including both manufacturer promotions and retailer promotions. In accordance with one embodiment, auto replenishment service 112 sends to account holders 104 through app 106 promotions and sales via notification management 144. If account holder 104 finds a deal that they would like to take advantage of, they can simply change their default consumable to the promotional consumable.

Still further, within data layer 132 is stored information about account holder 104 including the types of consumables linked to their smart devices that they are having automatically ordered and delivered. Using this information, auto replenishment service 112 can send other types of discovery topics in the form of notifications including replenishment suggestions, related device suggestions, local events and services associated with the use of a particular type of consumable and purchasing recommendations related to merchandise that is associated with the consumable or is merchandise unassociated with the consumable, for example merchandise other than the consumable. Exemplary notifications may comprise email messages, in app messaging and text messages.

In particular, the purchasing recommendations may be organized and accomplished through affinity mapping or affinity graphs. In one embodiment, affinity maps can be used to make recommendations based on customer usage of their smart device. In another embodiment, affinity maps may compare a user's smart device use to a user base of other account holders with similar smart devices and the user base's usage of their similar smart devices. Further, affinity maps can be used to make recommendations based on a user's past purchase data for all products or merchandise purchased and not just consumables for their smart devices that are purchased. Still further, the user base of account holders with similar smart devices and their past purchase data for all products or merchandise purchased can be used to make purchasing recommendations.

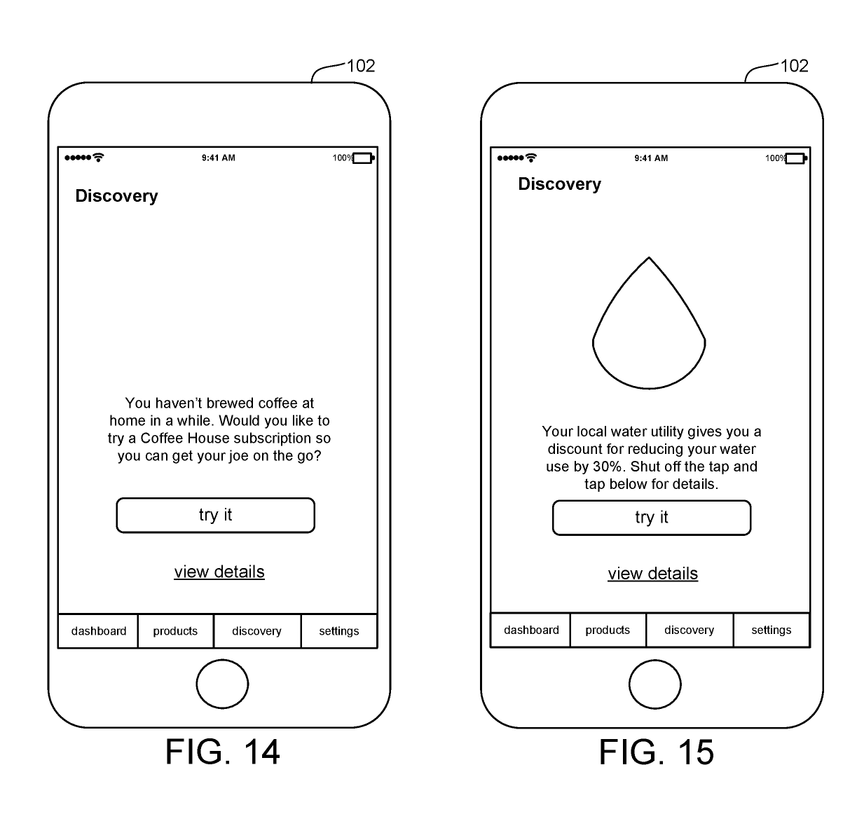

FIG. 14 illustrates mobile device 102 and an associated screenshot showing an exemplary discovery feature of the auto replenishment service 112. In this embodiment, the discovery feature is an associated service based on use of a consumable, in this case coffee, and how a coffee house subscription is available if account holder 104 finds themselves too busy to brew coffee at home. Other services not illustrated include a composting service for composting coffee grounds or as illustrated in FIG. 15 notification that the account holder's local utility gives a discount for reducing your water consumption by 30%.

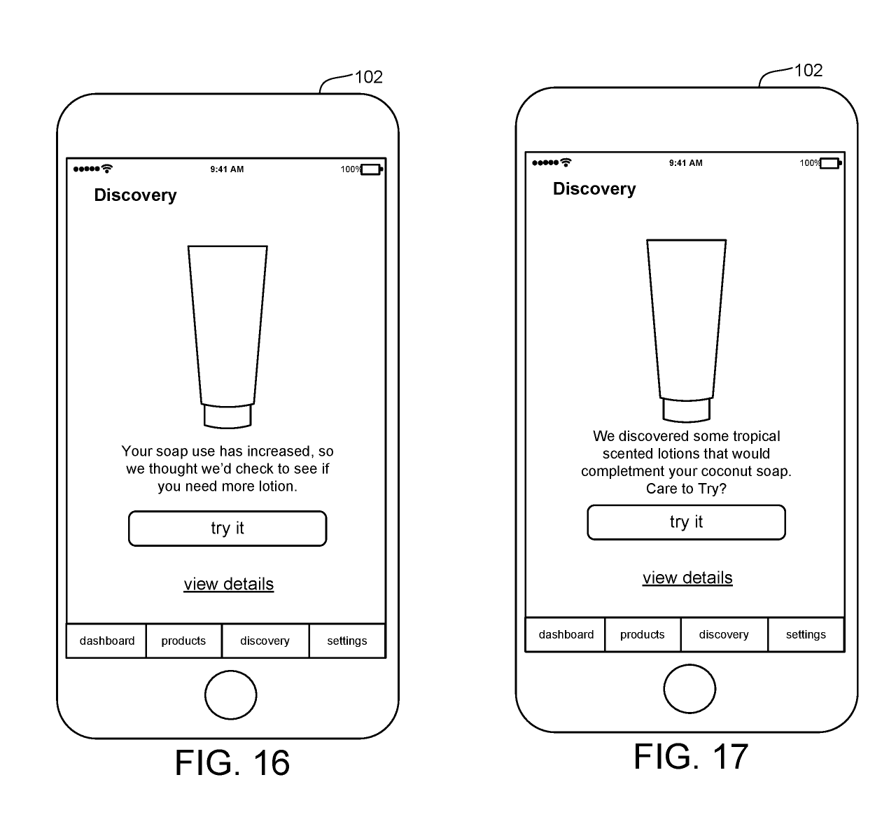

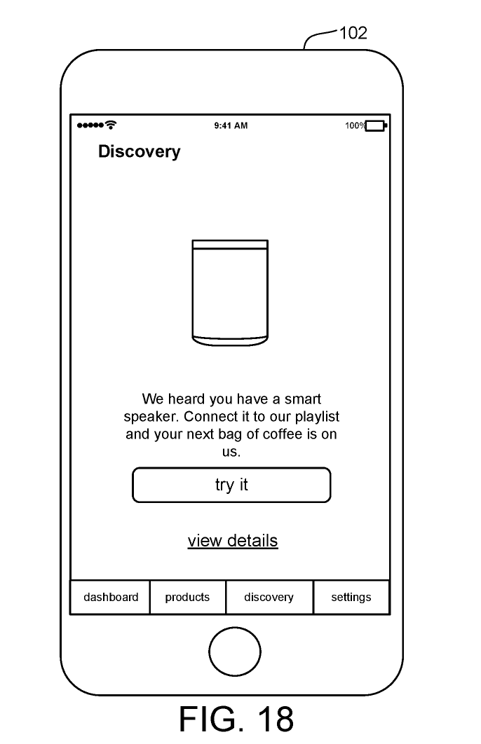

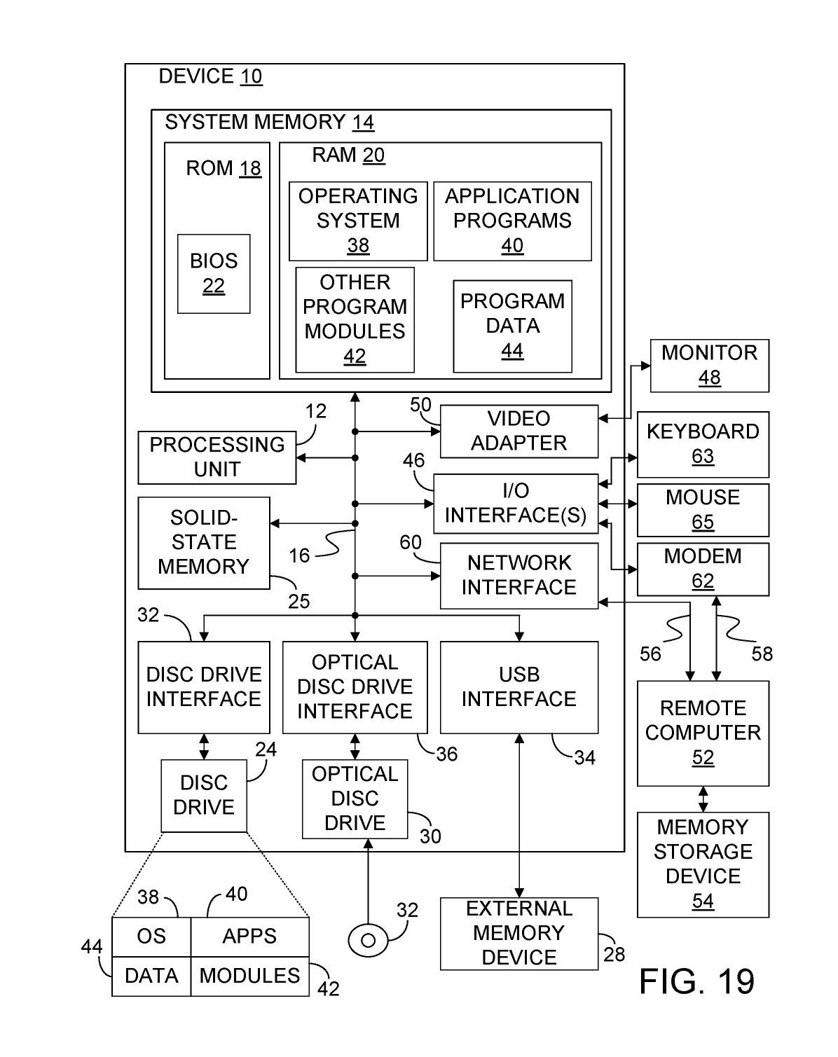

FIG. 16 illustrates mobile device 102 and an associated screenshot showing an exemplary discovery feature because of the account holder's increased use of a consumable. The idea of purchasing lotion is sent to account holder 104. In FIG. 17, the idea of sending a particular scent of lotion based on the account holder's use of a particular kind of soap is shown. In FIG. 18 and yet another embodiment, a service unrelated to the consumable being reordered is sent to account holder 104 based solely on a promotion. In this case, auto replenishment service 112 knows about a smart device purchase made by account holder 104 for a smart speaker and also fulfills orders of consumables for account holder's smart coffee maker. Given this, the promotion provides a free consumable if account holder 104 connects their smart speaker to a particular playlist.

FIG. 19 provides an example of a computing device 10 that can be used as a server device or client device or mobile in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing website design server 212 and search server 228 including programs for implementing taxonomy viewer app 204, taxonomy builder 206, page modification app 208 (webpage update application 208), item update events 210, page assignment app 248, attribution builder 220 and search service 224, for example. Program data 44 may include data such as attributions 222, page versions 207, item entries 230, and item database 226, for example.

Processing unit 12, also referred to as a processor, executes programs in system memory 14 and solid state memory 25 to perform the methods described above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 12. The network connections depicted in FIG. 12 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIGS. 1 and 2 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. An auto replenishment system comprising:
an auto replenishment service being in Internet communication with a smart device registered with the auto replenishment service and monitors consumption of consumables by the smart device for an account holder, wherein the auto replenishment service receives consumption events and processes the consumption events to automatically request orders for the consumable on behalf of the account holder from a retail fulfillment service over the Internet and comprises:
an event processor that recalculates an amount of the consumable associated with the registered smart device based on the consumption events;
a prediction engine that determines, based on historical use of the consumable by the registered smart device, whether the consumable needs to be restocked; and
an order management component that sends notification to the retail fulfillment service requesting a reorder of the consumable.

2. The auto replenishment system of claim 1, wherein the auto replenishment service updates and stores a new amount of the consumable associated with the registered smart device, the new amount of the consumable being a sum of an amount of the consumable calculated by the event processor to be remaining and an amount of the reordered consumable.

3. The auto replenishment system of claim 1, further comprising a mobile device having an embedded app that includes a user interface for the auto replenishment service, wherein the auto replenishment service receives information from the account holder through the user interface in the app.

4. The auto replenishment system of claim 1, wherein the retail fulfillment service comprises a plurality of retail fulfillment services that each provide consumables but at respective different prices.

5. The auto replenishment system of claim 1, wherein the auto replenishment service sends notifications directly to the account holder, the notifications comprising email messages, in app messaging or text messaging.

6. The auto replenishment system of claim 5, wherein the notifications comprise purchasing recommendations related to merchandise other than the consumable.

7. The auto replenishment system of claim 6, wherein the purchasing recommendations are based on information related to a user base of other account holders with similar smart devices as the smart device that belongs to the account holder.

8. The auto replenishment system of claim 6, wherein the purchasing recommendations are based on information related to past purchases of the account holder.

9. A method of automatically reordering a consumable for a smart device, the method comprising:
receiving, by a processor, an event involving use of the consumable by a registered smart device;
calculating, by the processor, a remaining amount of the consumable associated with the registered smart device based on the received event;
determining, by the processor, based on the remaining amount and historical use of the consumable by the registered smart device, whether the consumable needs to be restocked for the registered smart device; and
requesting a retail fulfillment service to reorder the consumable.

10. The method of claim 9, further comprising updating and storing, by the processor, a new amount of the consumable associated with the registered smart device, the new amount of consumable being a sum of the calculated amount of remaining consumable and an amount of reordered consumable.

11. The method of claim 9, further comprising registering, by a processor, an account holder and associating, by the processor, the registered smart device with the account holder.

12. The method of claim 9, wherein requesting the retail fulfillment service to reorder the consumable comprises requesting one of a plurality of retail fulfillment services to reorder the consumable at a best price.

13. The method of claim 11, further comprising sending notifications directly to the account holder, the notifications comprising email messages, in app messaging or text messaging.

14. The method of claim 13, wherein sending the notifications directly to the account holder comprises sending purchasing recommendations to the account holder related to merchandise other than the consumable.

15. The method of claim 14, wherein the purchasing recommendations are based on information related to a user base of other similarly registered smart devices as the smart device registered to the account holder.

16. The method of claim 14, wherein the purchasing recommendations are based on information related to past purchases of one of the account holder and the user base of other similarly registered smart devices as the smart device registered to the account holder.

17. An auto replenishment system comprising:
a plurality of smart devices each configured to consume a consumable, wherein the plurality of smart devices perform similar and different functionalities from each other and provide consumption events related to consumption of the consumable; and
an auto replenishment service in communication with the plurality of smart devices and configured to receive the consumptions events from each of the plurality of smart devices for processing, wherein the auto replenishment service recalculates an amount of the consumable available to each smart device based on the consumptions events, determines, based at least on historical use of the consumable used by each smart device, whether the consumable needs to be reordered and reorders the consumable from a retail fulfillment service based on the determination.

18. The auto replenishment system of claim 17, wherein each of the plurality of smart devices are registered with the auto replenishment service under an account holder.

19. The auto replenishment system of claim 17, wherein each of the plurality of smart devices are manufactured by a third party, wherein the third party on-boards specific smart device models with the auto replenishment service that comprise the plurality of smart devices.

20. The auto replenishment system of claim 17, further comprising a plurality of mobile devices that control one or more of the plurality of smart devices through a third party app and embedded within the third party app is a user interface for the auto replenishment service.
